(19) United States
(12) Patent Application Publication
(10) Pub. No.: US 2026/0084346 A1
(43) Pub. Date: Mar. 26, 2026

(54) METHOD FOR RECYCLING POLYESTER CONTAINERS

(71) Applicant: ALPLA WERKE ALWIN LEHNER GMBH & CO. KG, Hard (AT)

(72) Inventors: Daniel GOLDENSTEIN, Lochau (AT); Bryan-Cody BORCHERS, Geilenkirchen (DE)

(21) Appl. No.: 18/858,264

(22) PCT Filed: Apr. 20, 2023
(86) PCT No.: PCT/EP2023/060314

§ 371 Date: Oct. 18, 2024

(30) Foreign Application Priority Data
Apr. 22, 2022 (CH) CH 000464/2022

(51) Int. Cl. B29B 17/00; B29B 9/16; B29B 17/02; B29K 27/06; B29K 67/00; B29K 105/26; B29L 31/00

(52) U.S. Cl. CPC B29B 17/0052; B29B 2009/168; B29B 2017/0224; B29B 2017/0265; B29B 2017/0289; B29K 2027/06; B29K 2067/003; B29K 2105/26; B29L 2031/7158

(57) ABSTRACT

A method for recycling polyester containers, in particular PET containers, said method including the following method steps: sorting the containers, comminuting the containers to produce flakes, friction washing the flakes, sorting the flakes, and extruding and granulating the cleaned flakes. The flake-sorting process is used to separate flakes which have a foreign polymer that is different from the polyester, and the flake-sorting process is a combination of a color-sorting process, a screening step, and polymer-sorting process.

### FIELD OF THE INVENTION

The invention relates to a method for recycling polyester containers according to the preamble of claim 1.

### PRIOR ART

PET belongs to the most widely used types of plastic in the world, and recycling this type of plastic is especially important for the use of existing resources.

Some sources of PET recycling streams contain non-PET components (e.g., PVC, PS, PA, PE, PP), which may be attributed to regional markets and their production and waste treatment infrastructures. Different packaging designs are the result of specific visual or technical requirements set by the production process and/or customers. For example, the materials used for bottles, sleeves, and closures can lead to non-PET contamination and non-bottle applications, some of which may be present in the incoming bale material.

These non-PET components significantly affect the quality of the PET flakes that are extruded to produce rPET bottles and containers. However, to date, it has not been possible to improve the detection devices in a PET recycling stream from a mixed collection to such an extent that the chlorine content in the cleaned and sorted stream is significantly below a concentration of 30 ppm before extrusion. The chlorine content is usually determined using X-ray fluorescence analysis.

### OBJECT OF THE INVENTION

The disadvantages of the prior art described give rise to the object of improving the method for recycling polyester containers (in particular PET bottles and PET trays) in such a way that as much non-polyester material, in particular PVC, as possible is removed from the recycling stream, thereby enabling the resulting recycled polyester to be used in the food sector.

### DESCRIPTION

The object posed is achieved in a method for recycling polyester containers, in particular PET containers, by the features listed in the characterizing part of claim 1. Developments and/or advantageous alternative embodiments form the subject matter of the dependent claims.

The invention is preferably characterized in that the flake-sorting process d is used to separate flakes which have a foreign polymer different from polyester, and the flake-sorting process d is a combination of a color-sorting process d1, a screening step d2, and a polymer-sorting process d3, d4. This triple combination for removing flake contamination allows in particular flakes that contain PVC to be removed from the flake stream. These are particularly undesirable in the flakes before they are extruded into pellets, as the pellets cannot meet the requirements for food packaging if they contain PVC.

In a particularly preferred embodiment of the invention, at least a first and second screened fraction of flakes is produced in the screening step. Especially in the second screened fraction, which has small flakes (smaller than the limit grain size of the screen arrangement), a particularly high amount of PVC or chlorine accumulates, which can be removed as fully as possible from the screened fractions. The high content of PVC flakes in the fine fraction is due to the fact that PVC is more brittle than PET and is highly comminuted in the friction washing process.

It is preferable for the first screened fraction to have flakes having a grain size>1 mm and for the second screened fraction to have flakes having a grain size<x mm. This produces fractions which can be treated differently after the screening step d2 in order to remove as much contamination, especially PVC, as possible from the flake stream.

In a further preferred embodiment of the invention, a third screened fraction is produced in the screening step d2 which has flakes having a grain size<1 mm, and thus the second screened fraction has a grain size between 1 and x mm. This creates a very fine fraction which has a particularly high concentration of foreign polymers, especially PVC. This fraction can be recycled or disposed of without further sorting steps.

Expediently, the grain size limit is x=5 mm, preferably 4=mm, and particularly preferably x=3 mm. This produces fractions which can be supplied to different types of polymer-sorting processes d3, d4 in order to achieve a maximum contamination sorting rate.

It has proven useful if the polymer-sorting process d3, d4 is carried out immediately after the screening step (d2). This allows the second and third screened fractions to be immediately freed of contamination before further method steps are carried out.

In a further particularly preferred embodiment, the polymer-sorting process d3, by which foreign polymers in the second screened fraction are removed, constitutes a non-optical polymer-sorting process, in particular an electrostatic polymer-sorting process. Since PVC accumulates more in the second fraction, and the optical sorting process reaches its resolution limits at this grain size, the electrostatic polymer-sorting process therefore significantly increases the degree to which the flake stream is cleaned. Centrifuges, air classifiers, etc., are also conceivable for non-optical polymer sorting.

Expediently, the polymer-sorting process d4, by which foreign polymers in the first screened fraction are removed, is an optical polymer-sorting process. The optical sorting process is reliable for these grain sizes, especially over 3 mm. Near-infrared or laser technology is preferably used for optical detection.

It is expedient to carry out the color-sorting process d1 before the screening step d2. The optical color-sorting process has higher resolution rates and can therefore be used more flexibly. In the event of contamination, in all grain classes, the material flow can undergo color sorting in advance to simplify process technology/reduce the number of machines.

According to a further embodiment of the invention, it is also conceivable for the color-sorting process d1 to take place after the polymer-sorting process d3, d4. This arrangement is particularly useful when a grain class is immediately disposed of and if there are any color contaminants in this specific grain class.

It has proven advantageous for the color-sorting process d1 to be carried out after mixing the first and second screened fractions. This allows the color-sorting process d1 to be carried out as the final step of the flake-sorting process d before the flakes are extruded or temporarily stored prior to extrusion.

The invention is also preferably characterized in that the first and second screened fractions are sorted separately in a first and second color-sorting process d11, d12. This has the advantage that the first and second color-sorting processes d11 and d12 can be carried out particularly accurately, since two screened fractions are color-sorted separately. Accordingly, it is also possible to adapt the first and second color-sorting processes to the respective flake sizes of the first and second screened fractions and thus optimize the color recognition process.

In a further preferred embodiment of the invention, the cleaned flakes of the first and second screened fractions are stored in a flake store f in a defined ratio. This means that the necessary flake composition for producing the rPET pellets can be stored and fed to the extrusion e at any time.

In a further preferred embodiment of the invention, some of the cleaned flakes of the first and second screened fractions are temporarily stored in a first and second intermediate store g1, g2, and the temporarily stored flakes are fed to the flake store f in a defined ratio. The first and second screened fractions can therefore be stored separately before being mixed. It is also conceivable for the flakes of the first and second screened fractions not to be mixed and to be processed separately.

It is preferred if the foreign polymer is PVC. Especially in mixed collections, PVC is the predominant contamination and is particularly disruptive, since the rPET produced may not be used for the production of food containers if the PVC content is too high. The present method enables rPET granules to be produced with such purity that the quality requirements are reliably met for use in the food sector.

In a further particularly preferred embodiment of the invention, the third screened fraction is fed to a disposal h. The term “disposal” is also to be understood to include other types of utilization, such as thermal utilization or chemical recycling. In this third, fine screened fraction having flakes smaller than 1 mm (PET Fines/PET Dust), the PVC content is particularly high, and up to 90 times higher than in the other screened fractions. This is because PVC is more brittle than PET and is greatly comminuted during friction washing. The utilization of the third screened fraction is therefore extremely efficient, in order to obtain the cleanest possible flake stream.

It has proven to be advantageous for the friction washing step c to be carried out at temperatures>55° C. Flakes of collected recyclable PET bottles are reliably freed from residual bottle contents and other contaminants during a hot wash.

If the containers to be recycled are PET trays, the flakes must be subjected to a “cold wash” at a washing temperature below 55° C. so that the flakes do not become even finer at higher washing temperatures.

In a further preferred embodiment of the invention, the electrostatic polymer-sorting process d3 is carried out by charging the polyester flakes and foreign polymer flakes to different extents and dividing them into different flake streams in a high-voltage electric field. In combination with the screening step, this achieves extremely precise separation of foreign polymers.

Further advantages and features can be found in the following description of three exemplary embodiments of the invention with reference to the schematic drawings. In the figures, in a representation that is not to scale:

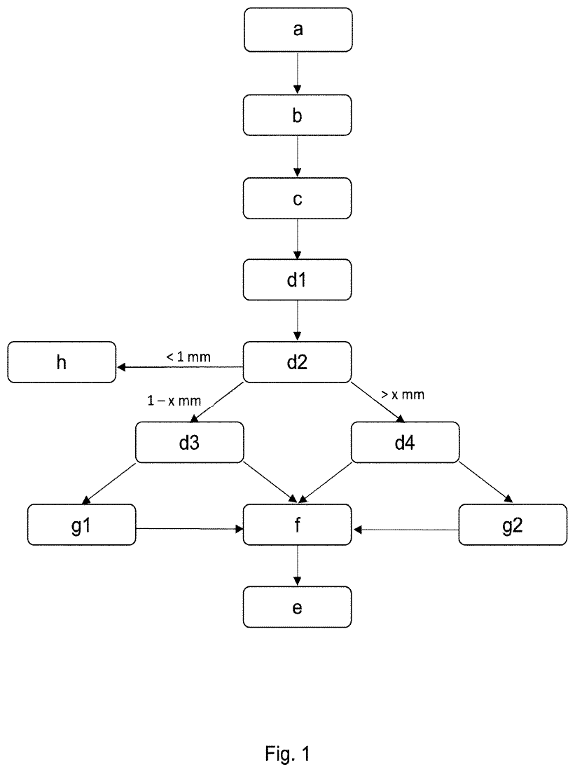

FIG. 1 is a first flow diagram showing a first embodiment of a method for recycling PET containers;

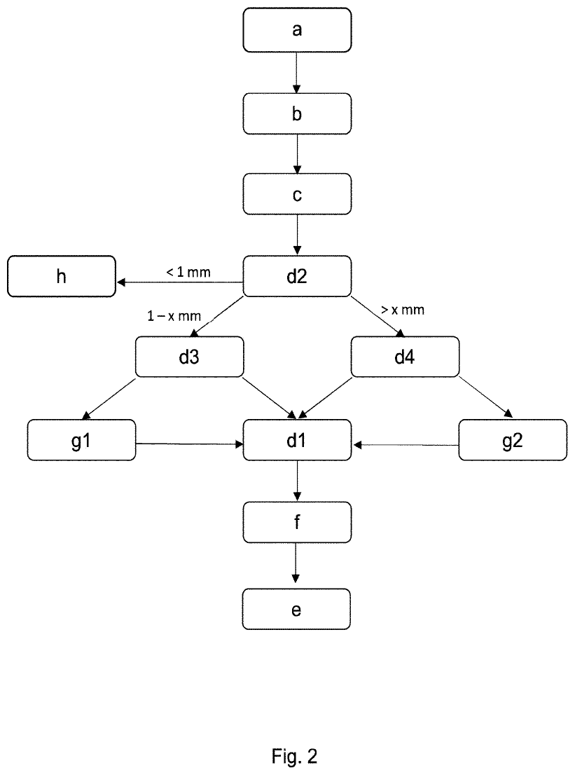

FIG. 2 is a second flow diagram showing a second embodiment of the method for recycling PET containers;

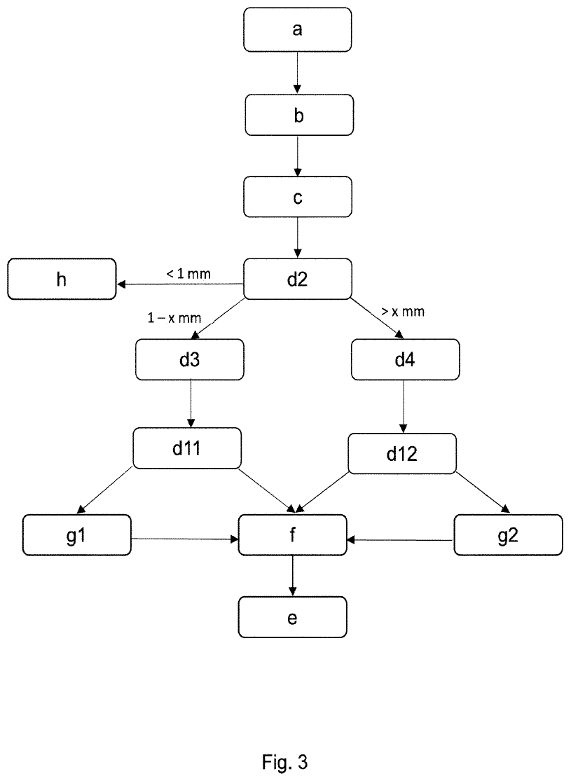

FIG. 3 is a third flow diagram showing a third embodiment of the method for recycling PET containers; and

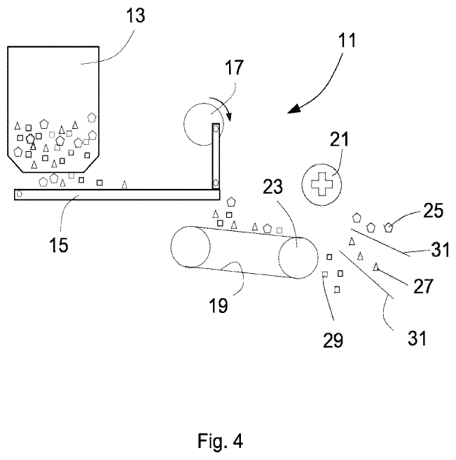

FIG. 4 is a functional scheme of the electrostatic polymer-sorting process.

FIGS. 1 to 3 show three embodiment variants of an improved method for recycling PET containers. This method is mostly applied to PET containers, although the method is also suitable for containers made of other polyesters. The containers are in particular PET bottles or PET trays. Method steps a to c are known in principle. In step a, the PET bottles or PET trays supplied for recycling are sorted. This is done using color sorting and near-infrared (NIR) technology. Before sorting the bottles, a method step for removing metals and labels may also be provided. The PET bottles can also be pre-cleaned. In step b, the PET bottles are comminuted into flakes, in particular ground in a mill. In step c, the flakes are washed using friction washing, with the washing temperature exceeding 55° C. for efficient cleaning. For PET trays, washing step c must be carried out in a “cold wash” at a washing temperature below 55° C., because at higher washing temperatures the flakes from PET trays undesirably become even finer.

Typical flake sizes for PET after the mill lie within the target range of 4-12 mm, depending upon the mill used. However, during the washing process c, a high level of friction is generated between the flakes, causing the flakes to break down into finer pieces. It is noticeable that PVC in particular is very brittle, and flakes in the <4 mm region and especially in the <1 mm region accumulate strongly. The chlorine content in flakes<1 mm (PET fines/PET dust) is up to 90 times higher than in “standard” PET flakes—at least, however, 10 times higher. Therefore, as described below, the flakes are screened in order to obtain different screened fractions.

The flake-sorting process d is carried out in a combination of several separation steps, specifically a color-sorting process d1, screening or a screening step d2, and a polymer-sorting process d3, d4. This makes it possible to remove foreign polymer flakes (unwanted contamination in the flake stream), which differ from polyesters, especially PET, from the flake stream to an extent than was previously not possible with prior-art separation methods. PVC in particular is considered to be a foreign polymer that must be removed from the flakes as much as possible. Only by removing the flakes containing PVC as completely as possible can the recycled PET flakes also be processed to produce containers that are filled with foodstuffs.

The color-sorting process d1 is usually carried out using color cameras, sometimes in combination with near-infrared (NIR), and usually takes place in a specially designed sorting system. The color-sorting process d1 removes flakes that could affect the desired color of the containers made from the recycled granulate.

The ground, (hot-) washed, & color-sorted flakes are split up into their sizes in the screening step d2 using a machine-driven screen or two screens in order to be able to further treat all the flake sizes in the best possible way. The initial fraction is divided into a first, second, and third fraction:

$$\begin{matrix}1. > x mm fraction \\ 2. 1 - x mm fraction \\ 3. < 1 mm fraction\end{matrix}$$

where the limit grain size x is 5 mm, preferably 4 mm, and particularly preferably 3 mm.

The third fraction of <1 mm is considered a side stream for a different type of recycling process and is disposed of accordingly if the foreign polymer is PVC (disposal h), since PVC largely accumulates in the third fraction as contamination. This fraction will therefore not be taken into account in the subsequent stages of the process.

The second fraction 1-x mm is handled separately and is further purified by electrostatic polymer-sorting process d3. This purification step cannot be carried out with optical systems because they here reach resolution limits. By means of polymer-sorting process d3, a large proportion of the contamination in the second fraction can be removed. It is also conceivable for the polymer-sorting process d3 to be density separation or for the electrostatic separation to be supplemented by density separation. This allows the fine PVC contamination to be removed from the second fraction. Density separators can be air classifiers, dust collectors, or hydrocyclones.

The fraction>x mm is handled separately and further cleaned by optical polymer-sorting process d4. For flakes larger than the limit grain size x, the contamination, especially the PVC flakes, can be detected preferably by NIR or laser detection technologies and removed via compressed air discharge. The color-sorting process d1, the screening step d2, and the polymer-sorting processes d3, d4 are performed by separate machines as described above.

Before extrusion e, the flakes must have undergone the flake-sorting processes d1, d2, and d3 or d4 to ensure maximum removal of contaminations, especially PVC flakes. The flakes cleaned in this way meet the quality requirements for use in the food sector.

The PVC content or wide variety of chemical elements in the flake stream can be detected using X-ray fluorescence (XRF) analysis. For PVC contamination, XRF can be used to determine the chlorine content, and thus indirectly determine the PVC content.

Common contaminations on the market are as follows:
rPET from the deposit stream (DE): 15-25 ppm chlorine
rPET from the mixed collection: >30 ppm chlorine (usually 30-70 ppm chlorine)

Common recycling processes:
rPET from the mixed collection without novel flake sorting: >30 ppm chlorine

The following values can be achieved with the present method:
rPET from the mixed collection including novel flake sorting: <25 ppm chlorine.

As can be seen from FIGS. 1 to 3, the polymer-sorting process d3 or d4 takes place immediately after the screening step d2. According to the first embodiment, as shown in FIG. 1, the color-sorting process d1 takes place before the screening step d2. However, the color-sorting process d1 can also be carried out after polymer-sorting d3, d4 (FIG. 2). The color-sorting process d1 can be carried out after mixing the first and second screened fractions (FIG. 2, 2nd exemplary embodiment), or the first and second screened fractions are each separately subjected to a first and second color-sorting process (d11, d12) before they are mixed (FIG. 3, 3rd exemplary embodiment).

The first and second screened fractions can be stored in a defined mixing ratio in a flake store f and retrieved for extrusion into pellets in the predetermined mixing ratio. To establish the mixing ratio, the flake store f is filled with defined mass flows of the first and second screened fractions.

The cleaned flakes of the first and second screened fractions can be temporarily stored in a first and second intermediate store (g1, g2) by diverting side streams. The temporarily stored flakes are fed to the flake store f in a defined ratio. This means that the first and second screened fractions can also be temporarily stored separately from one another.

Examples of screened fraction ratios are given in the 3 tables below for PET bottles:

TABLE 1
Distribution of the flakes in the three
screened fractions prior to sorting d

Proportion prior to sorting

| Screen size at x mm | <1 mm | 1-x mm | >x mm |
|---|---|---|---|
| x = 3 mm | 0.2% | 20% | 79.8% |
| x = 4 mm | 0.3% | 27% | 72.7% |
| x = 5 mm | 0.2% | 38% | 61.8% |

TABLE 2
Sorting losses of the flakes in the three screened fractions

| | Sorting losses (relative to each fraction) | | |
|---|---|---|---|
| Screen size at x mm | <1 mm | 1-x mm | >x mm |
| x = 3 mm | 100% | 5.4% | 0.8% |
| x = 4 mm | 100% | 3.2% | 0.7% |
| x = 5 mm | 100% | 4.1% | 0.5% |

TABLE 3
Distribution of the flakes in the three
screened fractions after sorting d

Proportion of final flake

| Screen size at x mm | <1 mm | 1-x mm | >x mm |
|---|---|---|---|
| x = 3 mm | 0% | 19.3% | 80.7% |
| x = 4 mm | 0% | 26.6% | 73.4% |
| x = 5 mm | 0% | 37.2% | 62.8% |

Examples of screened fraction ratios are given in the 3 tables below for PET trays:

TABLE 4
Distribution of the flakes in the three
screened fractions prior to sorting d

Proportion prior to sorting

| Screen size at x mm | <1 mm | 1-x mm | >x mm |
|---|---|---|---|
| x = 3 | 0.60% | 19% | 80.40% |
| x = 4 | 0.80% | 26% | 73.20% |
| x = 5 | 0.70% | 60% | 39.30% |

TABLE 5
Sorting losses of the flakes in the three screened fractions.

| | Sorting losses (relative to each fraction) | | |
|---|---|---|---|
| Screen size at x mm | <1 mm | 1-x mm | >x mm |
| x = 3 | 100% | 4.2% | 0.8% |
| x = 4 | 100% | 5.2% | 0.7% |
| x = 5 | 100% | 4.6% | 0.5% |

TABLE 6
Distribution of the flakes in the three
screened fractions after sorting d

Final flake proportion

| Screen size at x mm | <1 mm | 1-x mm | >x mm |
|---|---|---|---|
| x = 3 | 0% | 18.6% | 81.4% |
| x = 4 | 0% | 25.3% | 74.7% |
| x = 5 | 0% | 59.4% | 40.6% |

FIG. 4 shows a functional diagram for the electrostatic polymer-sorting process d3. The electrostatic-sorting process d3 in combination with the previous screening step d2 contributes to a particularly high separation efficiency for foreign polymers. The electrostatic separating device is designated as a whole by reference sign 11.

During electrostatic-sorting process d3, the PET and non-PET mixture is fed to a vibrating chute 15 via a feeder 13. The vibrating chute 15 is vibrated by a vibrating motor 17. The vibrating chute 15 acts as a charging unit (vibrating chute) with which the flake stream is electrically charged. The electrical charge is generated by friction between the different flakes, which is provoked during vibration in a very small space. Due to the friction, charges/electrons close to the surface are exchanged, and the PET becomes partially positively charged, while the PVC becomes more negatively charged.

This different load is subsequently the sorting criterion. For sorting purposes, a high-voltage electric field is applied from the outside, which attracts the PET particles or repels the PVC particles (or vice versa, depending upon the polarity of the voltage field). For this purpose, the charged flake stream is passed therethrough via a belt 19—for example, between a positive electrode 21 and a neutral electrode 23. In the example shown, the high-voltage field is therefore applied from the outside by means of a rotating roller which is positively charged and forms the positive electrode 21. The flake stream is split up by the negatively charged PVC flakes 25 being attracted to the positive electrode (cathode) 21 and the positively charged PET flakes 27 being repelled by the cathode. If even more positively charged PET-G (glycol-modified PET) 29 is present in the flake stream, it will be even more strongly repelled by the cathode. For this purpose, two or three flake streams can be formed, which are spatially separated by partition walls 31.

The triboelectric series shown in Table 7 can also be used to estimate which other polymers this process is suitable for. The greater the difference between 2 polymers shown at the top, the more feasible their separation. In the present method, for example, PA can also be separated as a positive side effect, since it is much more positively chargeable than PET.

TABLE 7
Triboelectric series of different polymers

| | |
|---|---|
| PUR Polyurethane PMMA Polymethyl methacrylate PC Polycarbonate PA Polyamide ABS Acrylonitrile butadiene styrene PS Polystyrene PE Polyethylene PP Polypropylene PET Polyethylene terephthalate RUC Chlorinated rubber PVDC Polyvinylidene chloride PVC Polyvinyl chloride PTFE Polytetrafluoroethylene | [symbol] |

### LIST OF REFERENCE SIGNS

a Container sorting
b Comminuting the containers into flakes
c Friction washing of the flakes
d Flake-sorting process
d1 Color-sorting process
d11 First color-sorting process
d12 Second color-sorting process
d2 Screening step
d3 Polymer-sorting process of the second screened fraction
d4 Polymer-sorting process of the first screened fraction
e Extrusion
f Flake store
g1 First intermediate store
g2 Second intermediate store
h Disposal
11 Electrostatic separator
13 Feeder
15 Vibrating chute
17 Vibrating motor
19 Belt
Positive electrode 21
23 Negative electrode
25 PVC flakes
27 PET flakes
29 PET-G flakes
31 Partition walls

1.-19. (canceled)

20. Method for recycling polyester containers, in particular PET containers, comprising the following method steps:
sorting the containers,
comminuting the bottles to form flakes,
friction washing the flakes,
sorting the flakes, and
extruding and granulating the cleaned flakes,
wherein
the flake-sorting process serves to separate flakes which have a foreign polymer other than polyester, and the flake-sorting process is a combination of:
a color-sorting process,
a screening step, and
a polymer-sorting process.

21. The method according to claim 20, wherein at least a first and second screened fraction of flakes is produced in the screening step.

22. The method according to claim 21, wherein the first screened fraction has flakes having a grain size>x mm, and the second screened fraction has flakes having a grain size<x mm.

23. The method according to claim 22, wherein a third screened fraction is produced in the screening step which has flakes having a grain size<1 mm, and thereby the second screened fraction has a grain size between 1 and x mm.

24. The method according to claim 22, wherein the limit grain size x=5 mm.

25. The method according to claim 20, wherein the polymer-sorting process takes place immediately after the screening step.

26. The method according to claim 20, wherein the polymer-sorting process, by which foreign polymers in the second screened fraction are removed, is a non-optical polymer-sorting process, in particular an electrostatic polymer-sorting process.

27. The method according to claim 20, wherein the polymer-sorting process, by which foreign polymers in the first screened fraction are removed, is an optical polymer-sorting process.

28. The method according to claim 20, wherein the color-sorting process takes place before the screening step.

29. The method according to claim 20, wherein the color-sorting process takes place after the polymer-sorting process.

30. The method according to claim 29, wherein the color-sorting process takes place after mixing the first and second screened fractions.

31. The method according to claim 20, wherein the first and second screened fractions are separately sorted in a first and second color-sorting process.

32. The method according to claim 21, wherein the cleaned flakes of the first and second screened fractions are stored in a flake store in a defined ratio.

33. The method according to claim 32, wherein some of the cleaned flakes of the first and second screened fractions are temporarily stored in a first and second intermediate store, and the temporarily stored flakes are fed to a flake store in a defined ratio.

34. The method according to claim 20, wherein the foreign polymer is PVC.

35. The method according to claim 23, wherein the third screened fraction is fed to a disposal.

36. The method according to claim 20, wherein the friction washing step is carried out at temperatures>55° C.

37. The method according to claim 20, wherein the friction washing step is carried out at temperatures<55° C.

38. The method according to claim 26, wherein the electrostatic polymer-sorting process is carried out by the polyester flakes and foreign polymer flakes being charged to different extents and being divided into different flake streams in a high-voltage electric field.
